(19) United States
(12) Patent Application Publication
(10) Pub. No.: US 2025/0217854 A1
(43) Pub. Date: Jul. 3, 2025

(54) DECISION ENGINE FOR ACCOUNT OFFERS

(71) Applicant: American Express Travel Related Services Company, Inc., New York, NY (US)

(72) Inventors: Manmeet Singh Duggal, Phoenix, AZ (US); Saurabh Gupta, Scottsdale, AZ (US); Kumar H Javarayappa, Peoria, AZ (US); Mohit Mehra, Phoenix, AZ (US); Paul Soumya, Phoenix, AZ (US); Arch Ratliff, Mesa, AZ (US); Thangavel Subramaniam, Scottsdale, AZ (US); Man Chon U, Weston, FL (US)

(21) Appl. No.: 18/400,229

(22) Filed: Dec. 29, 2023

(51) Int. Cl. G06Q 30/02; G06Q 30/0207; G06Q 30/0251; G06Q 40/02

(52) U.S. Cl. CPC G06Q 30/0281; G06Q 30/0215; G06Q 30/0255; G06Q 40/02

(57) ABSTRACT

Disclosed are various examples for utilizing a predictive model to generate alternative offers for customers viewing an initial account offer. Various user parameters can be collected from internal and external data sources. An analysis of the user parameters as well as user activity can be conducted. A predictive model can generate an alternative or personalized offer based at least in part upon the analysis.

### BACKGROUND

Selling new accounts to users can be an extremely difficult while also being extremely lucrative endeavor for card issuers. Users who attempt to secure an offer from a card issuer may find that they are ineligible for the offer after completing an application process. In some cases, users might be eligible for an even better offer from a card issuer than the one in which the user was initially interested. Matching a user with the right product can be a difficult process that can result in lost conversions in an industry where each new customer is extremely valuable.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a network environment according to various embodiments of the present disclosure.

FIG. 2 is a flowchart illustrating one example of functionality implemented as portions of an application executed in the network environment of FIG. 1.

FIG. 3 is a flowchart illustrating one example of functionality implemented as portions of an application executed in the network environment of FIG. 1.

FIG. 4 is a flowchart illustrating an alternative example of functionality implemented as portions of an application executed in the network environment of FIG. 1.

FIGS. 5-9 are user interface diagrams illustrating an example of a user experience with various embodiments of the present disclosure.

### DETAILED DESCRIPTION

Disclosed are various approaches for evaluating transaction account offers on behalf of a user. These approaches can include identifying an offer through the user establishing a session with a site associated with the transaction account issuer or promoter. Once the offer in which the user is interested is identified, other user parameters can be identified, such as a device from which the user is accessing the site, location and network parameters, information obtained from one or more browser cookies stored on the device of the user, and session information that can be obtained from a user session. Additionally, user parameters can be obtained from third party or external data sources about the user or the user session based at least in part upon information that can be identified about the user from the data that can be identified in the user session.

The session information can include real-time data that can be collected about the user, such as dwell time data that identifies which pages associated with an account issuer's site that a user has visited and how long the user has viewed certain pages corresponding to accounts offered by the issuer. Once the user parameters can be determined, examples of the disclosure can utilize a predictive model to generate a personalized offer for a transaction account that takes into account the user parameters that can be gathered for the user. Additionally, a transaction account offer can be identified and provided to the user in the user session without the need for performing an additional review of the user, such as a credit inquiry.

Examples of the disclosure propose a technical solution that allows computing devices evaluate users and make decisions to issue accounts to prospective customers without having to make a hard credit inquiry, thereby reducing the amount of time required to acquire and onboard customers. Additionally, examples of the disclosure can automatically redirect users from cards or accounts for which the users are unlikely to qualify for to other products, with automatically calculated welcome benefits that are generated by a predictive model, for which they are more likely without having to do hard credit inquiries, thereby again reducing the amount of time required to acquire and onboard customers.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

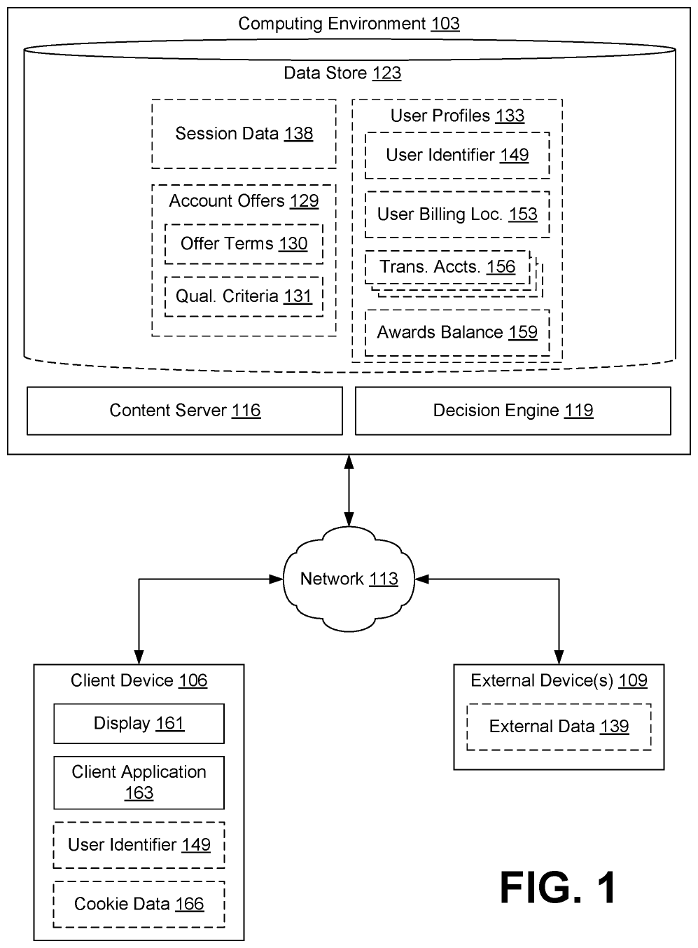

With reference to FIG. 1, shown is a network environment 100 according to various embodiments. The network environment 100 can include a computing environment 103, one or more client devices 106, and one or more external devices 109. The computing environment 103, the client device(s) 106, and the external device(s) 109 which can be in data communication with each other via a network 113.

The network 113 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 113 can also include a combination of two or more networks 113. Examples of networks 113 can include the Internet, intranets, extranets, virtual private networks (VPNs), and similar networks.

The computing environment 103 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 103 can employ a plurality of computing devices that can be arranged in one or more server banks or computer banks or other arrangements. Such computing devices can be located in a single installation or can be distributed among many different geographical locations. For example, the computing environment 103 can include a plurality of computing devices that together can include a hosted computing resource, a grid computing resource or any other distributed computing arrangement. In some cases, the computing environment 103 can correspond to an elastic computing resource where the allotted capacity of processing, network, storage, or other computing-related resources can vary over time.

Various applications or other functionality can be executed in the computing environment 103. The components executed on the computing environment 103 can include a content server 116, a decision engine 119, and other applications, services, processes, systems, engines, or functionality not discussed in detail herein.

Also, various data is stored in a data store 123 that is accessible to the computing environment 103. The data store 123 can be representative of a plurality of data stores 123, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the data store 123 is associated with the operation of the various applications or functional entities described below. This data can include one or more account offers 129, one or more user profiles 133, session data 138, and potentially other data.

An account offer 129 can represent an offer to open a transaction account, such as a credit card account, with a card issuer. The account offer 129 can be associated with offer terms 130 as well as qualification criteria 131. The offer terms 130 can comprise one or more incentives that can be associated with the account offer 129. The offer terms 130 can be marketed to users and comprise welcome benefits that can be provided to a user opening an account in accordance with the offer terms 130. For example, the offer terms 130 can comprise airline miles or points, hotel points, or other rewards points that can be awarded to a user account if and when certain requirements are met. The requirements can comprise a minimum spending requirement over a particular time period after the user opens the account, for example.

The offer terms 130 can also comprise cash benefits or statement credits that can be provided to the user upon opening an account and/or satisfying minimum spending requirements. The offer terms 130 can also comprise an introductory or lower interest rate in the case of accounts that permit the user to carry a balance. The introductory interest rate can comprise a lower interest rate that can be applicable to purchases or balances transferred to the account during an initial offer time period.

Qualification criteria 131 can comprise one or more criterion that a user must satisfy to qualify for a particular account offer 129. The qualification criteria 131 can comprise a minimum credit score, income level, age, residence, citizenship, or other requirements. Accordingly, determining whether a user qualifies for an account offer 129 can be a time-consuming process that is often shortcut by utilizing third party credit bureaus. However, users are often unwilling to allow too many credit inquiries into their identifies maintained by third party credit bureaus because too many inquires within too short a period of time can negatively impact the user's credit score. Additionally, a credit inquiry performed by an account issuer can take time, unnecessarily delaying a credit application process and resulting in a less than ideal user experience.

User profiles 133 can represent information about individual consumers who purchase goods or services using payment instruments (e.g., debit cards, credit cards, charge cards, etc.) for transactions authorized by the content server 116. Accordingly, a user profile 133 can include a user identifier 149, a user billing location 153, one or more transaction accounts 156, and an awards balance 159. The user identifier 149 can represent any identifier that uniquely identifies a user, and therefore the user profile 133, with respect to another user or user profile 133.

The user billing location 153 can represent the physical location associated with the user, and the location that communications (e.g., notices, bills, account statements, etc.) are mailed. Accordingly, the user billing location 153 could be represented by a mailing address and/or geographic coordinates (e.g., latitude and longitude coordinates). In some implementations, the user billing location 153 can also be used as a proxy for the point of origin of travel to a merchant, as further described in the discussion of the following figures.

The transaction accounts 156 represent payment instruments associated with a user. For example, a user could have multiple debit cards, credit cards, charge cards, stored-value payment instruments, etc. under his or her control. Each of these payment instruments could be represented as a transaction account 156 associated with the user profile 133. Each transaction account 156 can include its own unique transaction account identifier, such as payment card numbers that comply with the ISO/IEC 7812 standard.

The awards balance 159 can represent an amount or value of awards or rewards earned by the user represented by the user profile 133. The awards balance 159 can be in the form of points awarded by an issuer of a transaction account 156 to the user or as a cash-equivalent credit. Points or cash-equivalent credits may be awarded to the user in response to making purchases using the transaction account 156. For example, a predefined number of points may be awarded for each dollar spent, or a predefined number of points may be awarded for making a purchase with a specified merchant. In some cases, a user following a link provided as a part of an account offer 129 may have no user profile 133 with an account issuer.

Session data 138 can comprise information about a user session that is established on behalf of a user that visits a site provided by the account issuer or utilizes a mobile application provided by the account issuer that allows the user to view information about an account offer 129. The session data 138 can comprise information obtained from a browser or tracking cookie stored on the client device 106 to which the computing environment 103 can access or coordinate with to obtain user information. Cookie data 166 can be stored on the client device 106 can comprise information about the client device 106, such as a device manufacturer, operating system, a browser application, browser application, etc. The cookie data 166 can also comprise information about other sites the user might visit.

Examples of the disclosure can rely upon identifying various aspects of the user from user parameters that can be collected about the user from a user profile 133 that can be maintained and from external data sources. Examples of the disclosure can obtain data from one or more external device 109 that can house external data 139. The external data 139 can comprise user data obtained from third parties, such as third-party credit bureaus, consumer data, personal data sources, anonymized demographic data sources, and other consumer insight data from which credit decisions can be made by the decision engine 119.

The content server 116 can be executed to provide content, such as one or more web pages or content rendered in an application such as a mobile app, to a client device 106 of a user. A client device 106 can establish a session with the content server 116, which can provide content about various account offers 129 to the client device 106. The content server 116 can also request the decision engine 119 to render a decision about a user browsing a site or mobile application before rendering one or more pages that indicate approval or denial of a credit account. In some cases, the content server 116 can establish a user session on behalf of a user following a link to an account offer 129, such as via an advertising link, and then rely upon the decision engine 119 to render a decision about whether the user in fact qualifies for the account offer 129 based at least in part upon the session data, user profile 133 of the user, and external data 139 that is collected about the user and/or the user session.

The decision engine 119 can be executed to ingest user parameters obtained from various data sources and determine whether a user qualifies for an account offer 129. Additionally, the decision engine 119 can modify an account offer 129 to generate an offer with terms that are personalized for the user based at least in part upon the user parameters. In some instances, the decision engine 119 can provide a personalized account offer 129 to a client device 106 based at least in part upon an analysis of user parameters from the session data 138 corresponding to a user session. The decision engine 119 can utilize a predictive model that analyzes the user parameters to generate the modified or personalized offer to the user.

The decision engine 119 can collect data from internal and external data sources. Internal data sources can comprise a user profile 133 that might be maintained for a particular user. In some cases, a user with an existing account or an existing profile can access an account offer 129. Some account issuers can market new credit accounts or other types of products to existing users that already have one or more user accounts with the issuer.

The decision engine 119 can also utilize internal data such as session data 138 that is collected by the content server 116. The session data 138 can comprise data about interactions with a client device 106 with the content server 116. For example, the session data 138 can identify a link that the client device 106 followed to arrive at a page describing an account offer 129. The session data 138 can also comprise a device type of the client device 106, location data about the client device 106, and data obtained from cookie data 166 stored on the client device 106.

The decision engine 119 can utilize a predictive model to predict how profitable a user might be based at least in part upon an analysis of internal data and external data 139 relative to the account offer 129 that the user followed. The predictive model can utilize machine learning, a rules engine, and/or fuzzy logic. The decision engine 119 can be trained using preexisting user accounts and corresponding user profiles 133 as a training data set. For example, respective user profiles 133 can comprise a profitability score as well as identify which types of accounts and/or products offered by the account issuer that are linked to the user. Additionally, a respective user profile 133 can identify the parameters of an account offer 129 that the user followed to open a respective account with the account issuer. Accordingly, a predictive model utilized by the decision engine 119 to determine whether a given user would be a profitable customer for a particular account offer 129 can be trained on the existing customer base of the account issuer.

The predictive model of the decision engine 119 can also take into account external data 139 obtained from one or more external devices 109. The external data 139 can comprise data obtained from third parties that can be used as an inputs or as training data for the predictive model. The external data 139 can comprise personal data or anonymized demographic data about users regarding credit history, income levels, location, or other demographic data that can utilized by the predictive model to predict how profitable a particular account would be if offered to a user corresponding to a user session.

In some examples, the decision engine 119 can modify an account offer 129 that a given user follows or in which the user indicates interest based at least in part upon the predictive model. The decision engine 119 can modify the welcome benefits offered to the user based at least in part upon a determination that the user is potentially a highly profitable customer. In this scenario, the decision engine 119 can improve the welcome benefits offered to the user, such as rewards points, cash incentives, interest rate terms, or other welcome benefits that can be associated with the account offer 129. In other scenarios, the decision engine 119 might determine that a user fails to qualify for a given account offer 129. In this case, the decision engine 119 can offer an alternative product, such as an alternative credit card account, that has different or lesser welcome benefits based at least in part upon an analysis of the user parameters by the decision engine 119.

Additionally, the decision engine 119 can perform an analysis of the session data 138 and determine, based at least in part upon user behavior an alternative credit card account in which the user might be interest. The decision engine 119 can analyze dwell time within a browser or mobile application on certain pages or screens of a site or application of the account issuer. Based at least in part upon the offers in which the user indicates an interest, the decision engine 119 can generate an account offer 129 for the user. The dwell time can also incorporate which pages the user visits, which links the user taps or clicks, and the time that the user spends on the various pages or screens of an account issuer's site or application. The dwell time data can be obtained using client-side code that is executed by a client application 163 that the user utilizes to browse account offer 129 provided by the account issuer.

The client device 106 is representative of a plurality of client devices that can be coupled to the network 113. The client device 106 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 106 can include one or more displays 161, such as liquid crystal displays (LCDs), gas plasma-based flat panel displays, organic light emitting diode (OLED) displays, electrophoretic ink (“E-ink”) displays, projectors, or other types of display devices. In some instances, the display 161 can be a component of the client device 106 or can be connected to the client device 106 through a wired or wireless connection. The client device 106 can also include one or more wireless transmitters, such as near-field communications (NFC) transmitter, a BLUETOOTH radio, etc.

The client device 106 can be configured to execute various applications such as a client application 163 or other applications. The client application 163 can be executed by the client device 106 to access content provided by content server 116. For example, the client application 163 could represent a mobile banking application that allows a user to access information associated with his or her user profile 133 using his or her client device 106. A user can utilize the client application 163 to view information about account offers 129 that are marketed to users through ads or other user engagement tools.

The client device 106 can also store various types of information for use in the various embodiments of the present disclosure. For example, the client device 106 could store a user identifier 149, which allows a client device 106 to be associated with a user profile 133 of a specific user. However, the client device 106 could also store a device identifier that, if linked to or stored in the user profile 133, would also allow for the client device 106 to be similarly associated with a user profile 133 of a specific user. The client device 106 could also collect and store cookie data 166, which can include information user or device behavior that is collected by the client application 163 or by other applications running on the client device 106. The cookie data 166 could also include information such as location data, web browsing activity, and other data that the user authorizes to be tracked and potentially stored as cookie data 166 on the client device 106.

The external device 109 can represent a device or service operated by a third party from which the decision engine 119 can obtain external data 139. The external data 139 can comprise user data obtained from third parties, such as third-party credit bureaus, consumer data, personal data sources, anonymized demographic data sources, and other consumer insight data from which credit decisions can be made by the decision engine 119.

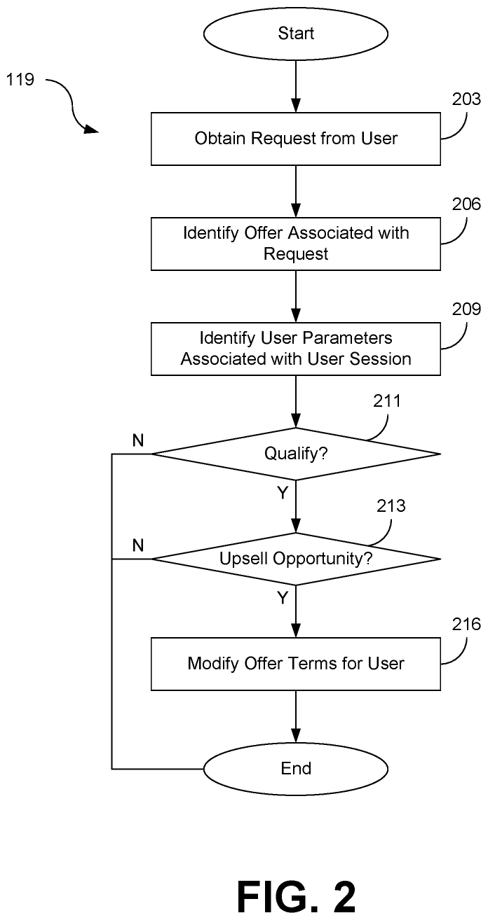

Referring next to FIG. 2, shown is a flowchart that provides one example of the operation of a portion of the decision engine 119. The flowchart of FIG. 2 provides merely an example of the many different types of functional arrangements that can be employed to implement the operation of the depicted portion of the decision engine 119. As an alternative, the flowchart of FIG. 2 can be viewed as depicting an example of elements of a method implemented within the network environment 100.

Beginning with block 203, the decision engine 119 can obtain a request from a user that is related to an account offer 129. The request can be provided by the content server 116 to evaluate user parameters associated with a user session established by the content server 116 in response to a client device 106 accessing an account offer 129 associated with a credit or financial product. The account offer 129 can be associated with one or more offer terms 130 or qualification criteria 131.

At step 206, the decision engine 119 can identify the specific account offer 129 associated with the request. As noted above, an account offer 129 can be associated with one or more offer terms 130, which can include welcome benefits associated with the account offer 129 that can be offered to the user if the decision engine 119 determines that the user qualifies for the account offer 129.

At step 209, the decision engine 119 can obtain user parameters associated with the user session. The user parameters can comprise information associated with cookie data 166 on the client device 106, browsing activity tracked by the content server 116 associated with the user session, external data 139 obtained from one or more one or more external devices 109, and/or data from a user profile 133 of the user if the user has a profile with the account issuer.

At step 211, the decision engine 119 can utilize a predictive model that analyzes the user parameters to determine whether the user qualifies for the account offer 129. The decision engine 119 can perform a dual analysis based at least in part upon the external data 139 and the user profile 133 and other internal data to make a prediction about whether the user qualifies for the account offer 129. In some implementations, the analysis can be performed without performing a credit inquiry of the user or even requiring a formal application to be submitted by the user for the account offer 129. The analysis can be a probabilistic determination based at least in part upon the activity exhibited by the user, the conditions under which the user accessed the account offer 129 via the content server 116, and from external data 139 that can profile user behavior. Because the decision engine 119 can utilize a predictive model that is trained on such data sets, the prediction can indicate whether the user qualifies for the account offer 129 without requiring the user to submit an application for the account offer 129. If the user fails to qualify for the account offer 129, the process can move from step 211 to completion.

If the user qualifies for the account offer 129, the process can move from step 211 to step 213, where the decision engine 119 can determine whether there is an upsell opportunity to provide the user with an improved account offer 129. If the predictive model utilized by the decision engine 119 determines that the user qualifies for an even improved set of offer terms 130 according to the qualification criteria 131 set forth by the account offer 129, the decision engine 119 can generate a modified or personalized account offer 129 that incorporates improved offer terms 130 to further incentivize the user to apply for the account offer 129. Alternatively, the decision engine 119 can also determine that the user qualifies for more premium product or account offered by the account issuer. If the decision engine 119 determines that the user does not qualify for an upsell opportunity, the process can proceed to completion.

At step 216, the decision engine 119 can modify the account offer 129 offered to the user. In some implementations, the decision engine 119 can seek approval of a modified set of offer terms 130 from an administrator. In other implementations, the decision engine 119 can be equipped with a set of guidelines that identify permissible ranges of modified offer terms 130 that can be offered to a user based at least in part upon an expected profitability of the user calculated or predicted by the predictive model. Thereafter, the process can proceed to completion.

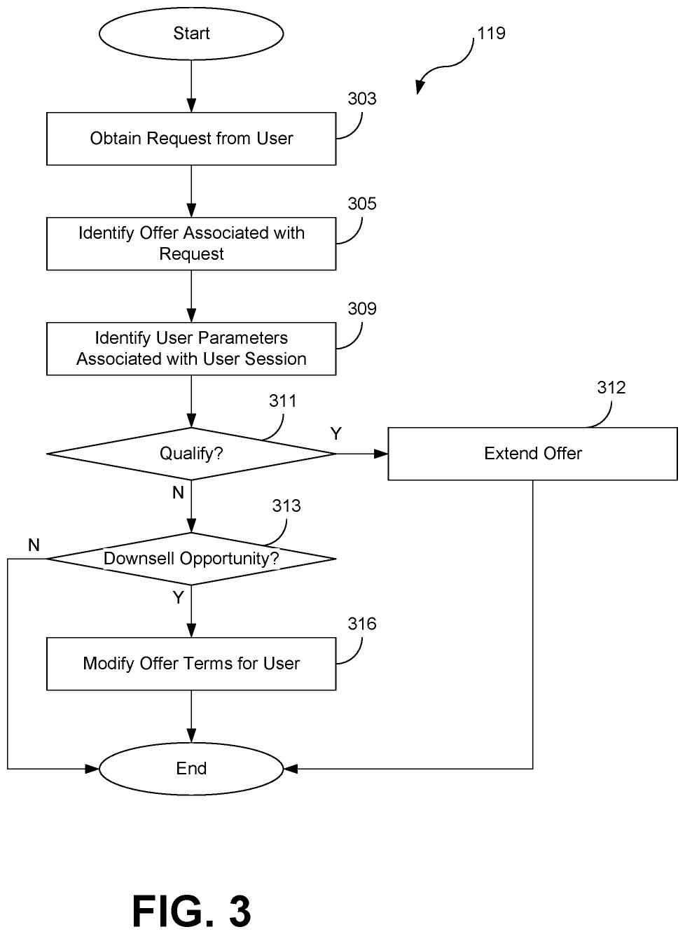

Referring next to FIG. 3, shown is a flowchart that provides one example of the operation of a portion of the decision engine 119. The flowchart of FIG. 3 provides merely an example of the many different types of functional arrangements that can be employed to implement the operation of the depicted portion of the decision engine 119. As an alternative, the flowchart of FIG. 3 can be viewed as depicting an example of elements of a method implemented within the network environment 100.

Beginning with block 303, the decision engine 119 can obtain a request from a user that is related to an account offer 129. The request can be provided by the content server 116 to evaluate user parameters associated with a user session established by the content server 116 in response to a client device 106 accessing an account offer 129 associated with a credit or financial product. The account offer 129 can be associated with one or more offer terms 130 or qualification criteria 131.

At step 305, the decision engine 119 can identify the specific account offer 129 associated with the request. As noted above, an account offer 129 can be associated with one or more offer terms 130, which can include welcome benefits associated with the account offer 129 that can be offered to the user if the decision engine 119 determines that the user qualifies for the account offer 129.

At step 309, the decision engine 119 can obtain user parameters associated with the user session. The user parameters can comprise information associated with cookie data 166 on the client device 106, browsing activity tracked by the content server 116 associated with the user session, external data 139 obtained from one or more one or more external devices 109, and/or data from a user profile 133 of the user if the user has a profile with the account issuer.

At step 311, the decision engine 119 can utilize a predictive model that analyzes the user parameters to determine whether the user qualifies for the account offer 129. The decision engine 119 can perform a dual analysis based at least in part upon the external data 139 and the user profile 133 and other internal data to make a prediction about whether the user qualifies for the account offer 129. In some implementations, the analysis can be performed without performing a credit inquiry of the user or even requiring a formal application to be submitted by the user for the account offer 129. The analysis can be a probabilistic determination based at least in part upon the activity exhibited by the user, the conditions under which the user accessed the account offer 129 via the content server 116, and from external data 139 that can profile user behavior. Because the decision engine 119 can utilize a predictive model that is trained on such data sets, the prediction can indicate whether the user qualifies for the account offer 129 without requiring the user to submit an application for the account offer 129. If the qualifies for the account offer 129, the process can move from step 311 to step 312, where the decision engine 119 returns a decision to extend an offer for the account offer 129 and the offer terms 130 to the user.

If the user fails to qualify for the account offer 129, the process can move from step 311 to step 313, where the decision engine 119 can determine whether there is a downsell opportunity to provide the user with an alternative account offer 129 because the user may not meet the qualification criteria 131 of the account offer 129 in which the user was initially interested. A downsell opportunity can comprise an opportunity to offer an alternative product to the user with lesser or less desirable offer terms 130 because the user may not qualify for the offer terms 130 associated with the account offer 129. If the predictive model utilized by the decision engine 119 determines that the user qualifies for an even improved set of offer terms 130 according to the qualification criteria 131 set forth by the account offer 129, the decision engine 119 can generate a modified or personalized account offer 129 that incorporates different offer terms 130 or an offer for a different product to incentivize the user to apply. If the decision engine 119 determines that the user does not qualify for any downsell opportunity, the process can proceed to completion.

At step 316, the decision engine 119 can modify the account offer 129 offered to the user. In some implementations, the decision engine 119 can seek approval of a modified set of offer terms 130 from an administrator. In other implementations, the decision engine 119 can be equipped with a set of guidelines that identify permissible ranges of modified offer terms 130 that can be offered to a user based at least in part upon an expected profitability of the user calculated or predicted by the predictive model. Thereafter, the process can proceed to completion.

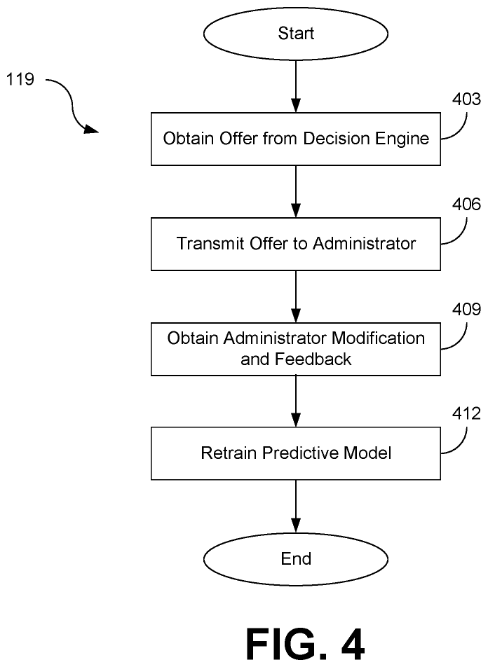

Referring next to FIG. 4, shown is a flowchart that provides an alternative example of the operation of a portion of the decision engine 119 to seek administrator approval or feedback of modified offers generated by the predictive model utilized by the decision engine 119. The flowchart of FIG. 4 provides merely an example of the many different types of functional arrangements that can be employed to implement the operation of the depicted portion of the decision engine 119. As an alternative, the flowchart of FIG. 4 can be viewed as depicting an example of elements of a method implemented within the network environment 100.

Beginning at block 403, the decision engine 119 can obtain a personalized or modified offer from the predictive model. The personalized or modified offer can be generated based at least in part upon the analysis of user parameters as described in the discussion of FIGS. 2-3. The personalized offer can have offer terms 130 that vary from a predefined account offer 129.

At step 406, the decision engine 119 can transmit the modified offer to an administrator. In some implementations, the decision engine 119 can wait until receiving administrator approval to offer the modified offer to a user. In other implementations, presentation of the modified offer to the administrator can be for the purposes of training the predictive model.

At step 409, the decision engine 119 can obtain administrator feedback or approval of the modified offer. The administrator feedback can comprise a revision of the offer terms 130 in the modified offer. For example, the administrator can modify the welcome incentives and/or the product itself in the modified offer.

At step 412, the decision engine 119 can retrain the predictive model utilized to generate modified offers based at least in part upon the administrator feedback received at step 409. Thereafter, the process can proceed to completion.

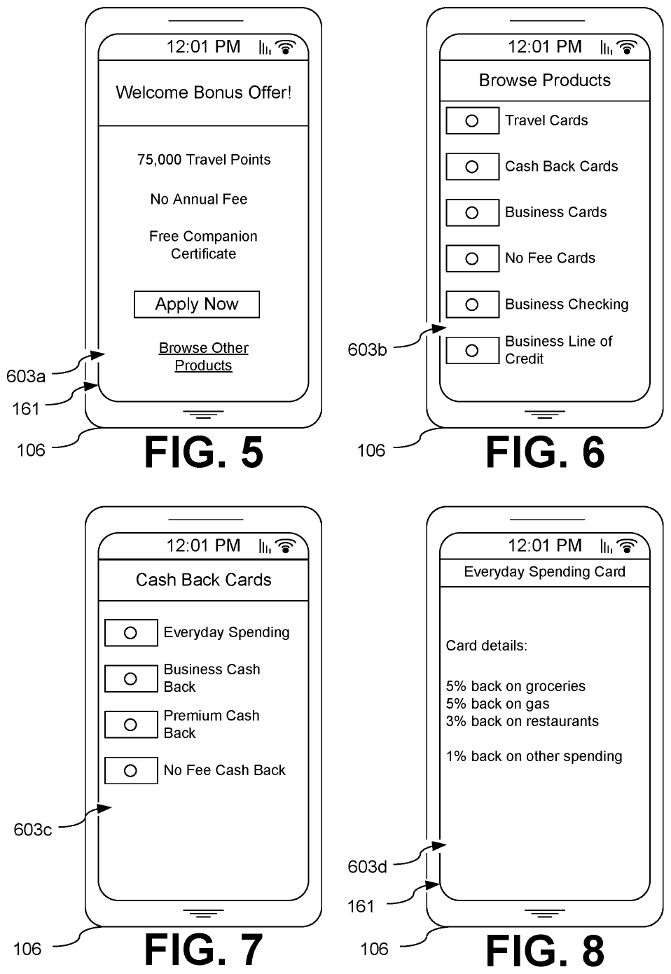

FIGS. 5-9 are user interface diagrams depicting an example user experience according to the various embodiments of the present disclosure as previously depicted in FIGS. 1-4.

Beginning with FIG. 5, an example of a client device 106 is illustrated. A user interface 603a can be generated by the client application 163 and presented to the user using the display 161 of the client device 106. The user interface 603a shown in FIG. 5 illustrates an example of an account offer 129 that can be viewed by a user in a client application 163. The client application 163 can comprise a browser application or an application distributed by the account issuer, such as a mobile application. A user can follow an advertisement link to view the account offer 129. The advertisement link can be shown on a third-party site, in an email or message sent directly to the user, or on the site or application of the account issuer.

The user interface 603a can illustrate the offer terms 130 and allow the user to apply for the account offer 129 or view other products offered by the account issuer. Additionally, the content server 116 can generate a user session corresponding to the user. The content server 116 can request that the decision engine 119 generate a decision about whether the user qualifies for the account offer 129 based at least in part upon user parameters gathered by the content server 116 during the session. The decision engine 119 can evaluate user parameters gathered on an ongoing basis during the visit of the user to the site or application of the account issuer.

Moving to FIG. 6, assume that the user does not immediately apply for the account offer 129 but browses other credit or financial products offered by the account issuer. As shown in the example user interface 603b of FIG. 6, the user can view various categories of products offered by an account issuer. The content server 116 can store the user's real-time browsing data as session data 138, which can specify the dwell time of the user on one or more pages or user interfaces presented to the user in the user interface 603b. Additionally, should the user follow any of the links to view any category in more detail, such browsing activity can be provided to the decision engine 119 and the predictive model utilized by the decision engine 119.

Moving to FIG. 7, if the user selects one of the product categories shown in FIG. 6, such as the “cash back cards,” the user can be presented with the products in the category by the content server 116. Additionally, the fact that the user selected the product category can be provided to the decision engine 119. The user interface 603c of FIG. 7 can allow the user to view the different product offerings in the selected category.

Then, in the scenario of FIG. 8, the user selects one of the product offerings in the selected product category. The user interface 603d can allow the user to view the offer terms 130 associated with the account offer 129. Additionally, the fact that the user viewed the account offer 129 can be provided to the decision engine 119 and the predictive model utilized by the decision engine 119.

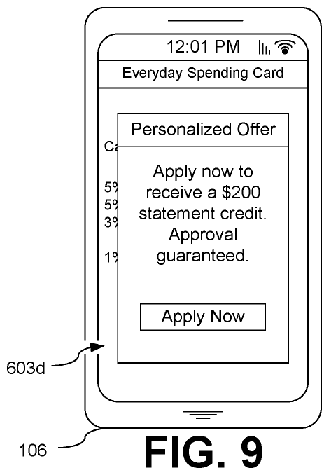

Then, as depicted in FIG. 9, the decision engine 119 can generate a personalized offer for the user based at least in part upon the user parameters, including browsing activity, dwell time, a user profile 133 of the user, and external data 139 obtained by the decision engine 119. The personalized offer can be generated by the predictive model of the decision engine 119 and can be associated with a transaction account that is different from the transaction account associated with the initial account offer 129 viewed by the user because the user may not qualify for the account offer 129, the user represents an upsell opportunity, or the user may be more interested in different products offered by the account issuer.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random access portion of the memory and run by the processor, source code that can be expressed in proper format such as object code that is capable of being loaded into a random access portion of the memory and executed by the processor, or source code that can be interpreted by another executable program to generate instructions in a random access portion of the memory to be executed by the processor. An executable program can be stored in any portion or component of the memory, including random access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random access memory (SRAM), dynamic random access memory (DRAM), or magnetic random access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random access memory (RAM) including static random access memory (SRAM) and dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment 103.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a computing device comprising a processor and a memory; and
machine-readable instructions stored in the memory that, when executed by the processor, cause the computing device to at least:
obtain a user request in response to a link associated with an offer to open a transaction account, the offer comprising a plurality of offer terms;
establish a user session with a device corresponding to the user request;
identify a plurality of parameters associated with the user request, the plurality of parameters obtained from the user session and a plurality of external data sources that correspond to the user session;
identify, based at least in part on the plurality of parameters associated with the user request, an alternative offer corresponding to the user session, the alternative offer comprising an alternative plurality of offer terms; and
transmit the alternative offer to the device in the user session.

2. The system of claim 1, wherein the machine-readable instructions cause the computing device to obtain a subset of the plurality of parameters from a browser session associated with the device, wherein the plurality of parameters comprise at least one tracking cookie associated with the user session.

3. The system of claim 1, wherein the machine-readable instructions cause the computing device to identify the alternative offer by modifying the plurality of offer terms based at least in part upon a predictive model that is trained using a training data set based at least in part upon the plurality of parameters obtained on a population of users accessing respective offers for a respective transaction account.

4. The system of claim 3, wherein the machine-readable instructions cause the computing device to identify the alternative offer by personalizing at least one of a welcome incentive, an annual percentage rate, or an annual fee, wherein personalizing is performed using the predictive model.

5. The system of claim 1, wherein the machine-readable instructions cause the computing device to identify the alternative offer by determining, based at least in part upon the plurality of parameters, that the user session is associated with an alternative transaction account relative to the transaction account associated with the offer.

6. The system of claim 1, wherein the machine-readable instructions cause the computing device to identify a plurality of parameters associated with the user request by identifying an amount of time the user views a respective offer on a site associated with a plurality of transaction accounts.

7. The system of claim 1, wherein the machine-readable instructions cause the computing device to identify a plurality of parameters associated with the user request based at least in part upon at least one previous interactions of the user with a site.

8. A method, comprising:
obtain a user request in response to a link associated with an offer to open a transaction account, the offer comprising a plurality of offer terms;
establish a user session with a device corresponding to the user request;
identify a plurality of parameters associated with the user request, the plurality of parameters obtained from the user session and a plurality of external data sources that correspond to the user session;
identify, based at least in part on the plurality of parameters associated with the user request, an alternative offer corresponding to the user session, the alternative offer comprising an alternative plurality of offer terms; and
transmit the alternative offer to the device in the user session.

9. The method of claim 8, further comprising obtaining a subset of the plurality of parameters from a browser session associated with the device, wherein the plurality of parameters comprise at least one tracking cookie associated with the user session.

10. The method of claim 8 wherein identifying the alternative offer further comprises modifying the plurality of offer terms based at least in part upon a predictive model that is trained using a training data set based at least in part upon the plurality of parameters obtained on a population of users accessing respective offers for a respective transaction account.

11. The method of claim 10, wherein identifying the alternative offer further comprises personalizing at least one of a welcome incentive, an annual percentage rate, or an annual fee, wherein personalizing is performed using the predictive model.

12. The method of claim 8, wherein identifying the alternative offer further comprises determining, based at least in part upon the plurality of parameters, that the user session is associated with an alternative transaction account relative to the transaction account associated with the offer.

13. The method of claim 8, further comprising identifying a plurality of parameters associated with the user request by identifying an amount of time the user views a respective offer on a site associated with a plurality of transaction accounts.

14. The method of claim 8, further comprising identifying a plurality of parameters associated with the user request based at least in part upon at least one previous interactions of the user with a site.

15. A non-transitory, computer-readable medium, comprising machine-readable instructions that, when executed by a processor of a computing device, cause the computing device to at least:
obtain a user request in response to a link associated with an offer to open a transaction account, the offer comprising a plurality of offer terms;
establish a user session with a device corresponding to the user request;
identify a plurality of parameters associated with the user request, the plurality of parameters obtained from the user session and a plurality of external data sources that correspond to the user session;
identify, based at least in part on the plurality of parameters associated with the user request, an alternative offer corresponding to the user session, the alternative offer comprising an alternative plurality of offer terms; and
transmit the alternative offer to the device in the user session.

16. The non-transitory, computer-readable medium of claim 15, wherein the instructions cause the computing device to obtain a subset of the plurality of parameters from a browser session associated with the device, wherein the plurality of parameters comprise at least one tracking cookie associated with the user session.

17. The non-transitory, computer-readable medium of claim 15, wherein the instructions cause the computing device to identify the alternative offer by modifying the plurality of offer terms based at least in part upon a predictive model that is trained using a training data set based at least in part upon the plurality of parameters obtained on a population of users accessing respective offers for a respective transaction account.

18. The non-transitory, computer-readable medium of claim 17, wherein the machine-readable instructions cause the computing device to identify the alternative offer by personalizing at least one of a welcome incentive, an annual percentage rate, or an annual fee, wherein personalizing is performed using the predictive model.

19. The non-transitory, computer-readable medium of claim 15, wherein the machine-readable instructions cause the computing device to identify a plurality of parameters associated with the user request by identifying an amount of time the user views a respective offer on a site associated with a plurality of transaction accounts.

20. The non-transitory, computer-readable medium of claim 15, wherein the machine-readable instructions cause the computing device to identify a plurality of parameters associated with the user request based at least in part upon at least one previous interactions of the user with a site.
